(19) United States
(12) Patent Application Publication
(10) Pub. No.: US 2010/0165523 A1
(43) Pub. Date: Jul. 1, 2010

(54) INTEGRATED CIRCUIT

(76) Inventor: Hee-Jeong SON, Gyeonggi-do (KR)

Correspondence Address: IP & T Law Firm PLC, 7700 Little River Turnpike, Suite 207, Annandale, VA, 22003, US

(21) Appl. No.: 12/640,934

(22) Filed: Dec. 17, 2009

(30) Foreign Application Priority Data
Dec. 26, 2008 (KR) 10-2008-0134636

(51) Int. Cl. H02H 9/04

(52) U.S. Cl. 361/56

(57) ABSTRACT

An integrated circuit includes: a pad configured to receive an external signal; an electrostatic discharge (ESD) protector coupled with the pad to provide an ESD path to a power source voltage line and a ground voltage line; an input buffer configured to receive the signal applied to the pad through an input terminal; and a PMOS transistor coupled between the input terminal of the input buffer and the ground voltage line, with a gate terminal coupled with the power source voltage line.

### CROSS-REFERENCE TO RELATED APPLICATIONS

The present application claims priority of Korean Patent Application No. 10-2008-0134636, filed on Dec. 26, 2008, which is incorporated herein by reference in its entirety.

### BACKGROUND OF THE INVENTION

Exemplary embodiments of the present invention relate to a semiconductor design technology, and more particularly, to a technology for protecting internal elements and internal circuits from electrostatic discharge (ESD).

Among internal circuits of integrated circuits (IC), semiconductor memory devices, and semiconductor devices, circuits configured with metal oxide semiconductor (MOS) components have high gate input impedance. Hence, gate oxide layers of MOS devices may be easily damaged by ESD. However, in fabricating high-performance, high-integrated semiconductor devices, the thickness of gate oxide layers of transistors included in internal circuits is decreasing. Therefore, semiconductor devices are often provided with ESD protection circuits for protecting internal circuits from ESD.

Integrated circuits, or the like, may be exposed to ESD during fabrication processes or in single-product states. This state is referred to herein as a non-operational state, because no power is supplied, as the integrated circuits, or the like, are not yet mounted on electronic systems for normal operation.

Standard models for the ESD phenomenon are used to evaluate the tolerance and performance of the ESD protection circuits, and to analyze the ESD's influence on the internal circuits. Generally, one of three common ESD modeling methods may be used. The first ESD modeling method is a Human Body Model (HBM) for a case where electrostatic charges charged in a human body are discharged to a semiconductor device. The second ESD modeling method is a Machine Model (MM) for a case where electrostatic charges charged in conductive machines are discharged to a semiconductor device during semiconductor fabrication processes. The third ESD modeling method is a Charged Device Model (CDM) for a case where electrostatics charges charged in the inside of a semiconductor device are discharged to an external ground or conductor during fabrication processes, e.g., a packaging process. Electrostatic charges, i.e., positive charges or negative charges, charged in semiconductor devices, or the like, are discharged by physical contact, or the like. Therefore, a flow direction of charges is determined by the polarity of charged charges.

An ESD protection circuit is configured with grounded-gate MOSFET (GGMOSFET), gate-coupled MOSFET (GCMOSFET), bipolar junction transistor (BJT), diode, and other MOS components. When ESD occurs, the GGMOSFET clamps a certain voltage generated by a parasitic BJT phenomenon, and transmits an over current through a voltage line. During a normal operation in which no ESD occurs, the ESD protection circuit is not considered a parasitic capacitance component to the semiconductor device, and may be modeled as a component with an additional influence, such as a leakage current.

FIG. 1 illustrates a conventional integrated circuit. Referring to FIG. 1, the integrated circuit includes a pad PAD for receiving an external signal, a first ESD protector 11A, a second ESD protector 11B, an input buffer 12, a GGNMOS transistor MN0, and a resistor R. The first ESD protector 11A and the second ESD protector 11B are coupled with the pad and provide an ESD path to a power source voltage (VDD) line 10A and a ground voltage (VSS) line 10B, respectively. The input buffer 12 receives the signal supplied to the pad through an input terminal N1. The GGNMOS transistor MN0 is coupled between the input terminal N1 and the VSS line 10B, and has a gate terminal coupled with the VSS line 10B. The resistor R is disposed on a signal transfer path between the pad and the input terminal N1 of the input buffer 12.

Herein, a substrate bias voltage terminal of the GGNMOS transistor MN0 is coupled with the VSS line 10B to receive a ground voltage.

The first ESD protector 11A and the second ESD protector 11B are each generally formed using a diode, a grounded gate MOSFET (GGMOS), a gate-coupled MOSFET (GCMOS), a bipolar junction transistor (MT), or other MOS devices. When ESD occurs, a current path is formed with the power source line to thereby protect an internal device and an internal circuit from an over-current.

Hereafter, the structure and operation of the above-described integrated circuit will be described in detail.

In normal operation mode, the internal circuit operates when a power source is applied to the integrated circuit. Since the ground voltage is applied to both the gate terminal and the substrate bias voltage terminal of the GGNMOS transistor MN0, the GGNMOS transistor MN0 maintains a turn-off state and does not affect the operation of the input buffer 12. Therefore, the input signal supplied through the pad is transferred to the input terminal N1 of the input buffer 12, and the input signal is buffered in the input buffer 12. In other words, the first ESD protector 11A, the second ESD protector 11B, and the GGNMOS transistor MN0 do not affect the operation of the input buffer 12, and thus are not regarded as parasitic capacitance components when operating in the normal operation mode.

Meanwhile, when the integrated circuit is in a non-operational state, the power source is not applied to the power source line. In this case, when ESD is released to the pad, a certain level of voltage generated by static electricity from the ESD is supplied before the first ESD protector 11A and the second ESD protector 11B can be driven, i.e., before they can turn on and form current paths to the VDD line 10A and the VSS line 10B, respectively. In response to this ESD-initiated voltage, the GGNMOS transistor MN0 transmits an over-current to the power source line, based on the BJT phenomenon occurring internally, to protect the input terminal N1 of the input buffer 12 from being damaged. However, since the substrate bias voltage terminal and gate terminal of the GGNMOS transistor MN0 are coupled with the VSS line 10B, a trigger voltage internally generated is relatively high. Therefore, the internal circuit and the internal device such as the input buffer 12 may be damaged in the initial stage of the ESD phenomenon, that is, before the first ESD protector 11A and the second ESD protector 11B are driven.

### SUMMARY OF THE INVENTION

An exemplary embodiment of the present invention is directed to an integrated circuit with enhanced resistance against electrostatic discharge (ESD) by using a PMOS transistor.

In accordance with an embodiment of the present invention, an integrated circuit includes: a pad configured to receive an external signal; an ESD protector coupled with the pad to provide an ESD path to a power source voltage line and a ground voltage line; and an input buffer configured to receive the signal applied to the pad through an input terminal.

The integrated circuit may further include a power source clamp coupled between the power source voltage line and the ground voltage line.

The integrated circuit may further include a resistor disposed on a signal transfer path coupled between the pad and the input terminal of the input buffer.

The power source clamp may provide the ESD path between the power source line and the ground voltage line when an over-voltage, or over-current, of higher than a predetermined level is applied.

The electrostatic discharge (ESD) protector may be selected from a diode, a grounded gate MOSFET (GGMOS), a gate-coupled MOSFET (GCMOS), a bipolar junction transistor (BJT) and other MOS devices.

When the power source is applied to the integrated circuit in a normal operation mode, the ground voltage may be applied to the gate terminal and substrate bias voltage terminal of the PMOS transistor.

The PMOS transistor may maintain a turn-off state without affecting the operation of the input buffer.

When the power source is not applied to the integrated circuit in a non-operational state, the gate terminal and substrate bias voltage terminal of the PMOS transistor are in a floating state.

The integrated circuit may further include a protecting unit coupled between the input terminal of the input buffer and the ground voltage line and enabled by the power source voltage line.

The protecting unit may include a PMOS transistor coupled between the input terminal of the input buffer and the ground voltage line, with a gate terminal coupled with the power source voltage line.

The PMOS transistor may be configured to transmit an over-current to the power source line, based on the MT phenomenon occurring internally, to protect the input terminal of the input buffer from being damaged when the ESD occurs to the pad.

The PMOS transistor may have a substrate bias voltage terminal coupled with the power source voltage line.

### BRIEF DESCRIPTION OF THE DRAWINGS

FIG. 1 illustrates a conventional integrated circuit.

FIG. 2 illustrates an integrated circuit in accordance with one embodiment of the present invention.

FIG. 3 illustrates an integrated circuit in accordance with another embodiment of the present invention.

FIG. 4 shows electrostatic discharge (ESD) test results of integrated circuits in accordance with one embodiment of the present invention.

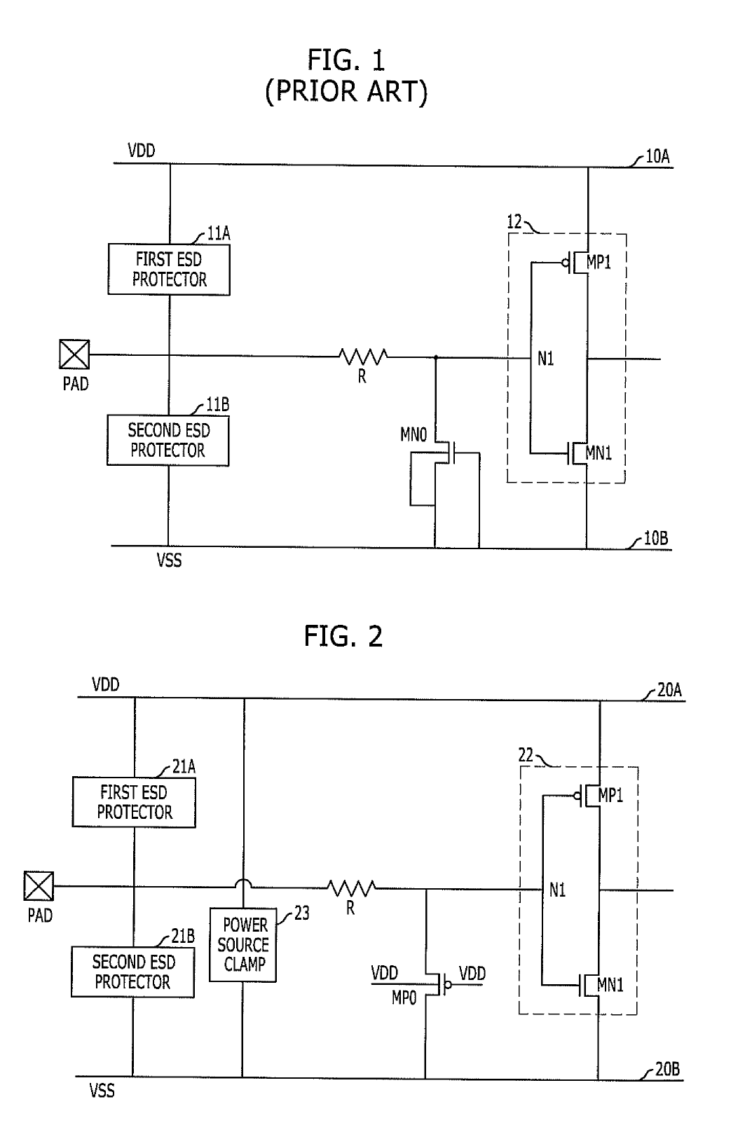

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The drawings are not necessarily to scale and in some instances, proportions may have been exaggerated in order to clearly illustrate features of the embodiments. When a first layer is referred to as being “on” a second layer or “on” a substrate, it not only refers to a case where the first layer is formed directly on, or over, the second layer or the substrate but also a case where a third layer exists between the first layer and the second layer or the substrate.

Generally, logic signals of a circuit are divided into a high level (H) and a low level (L) based on a voltage level and they may be represented by ‘1’ and ‘0,’ respectively. Also, it is defined and described that, if necessary, a high impedance (Hi-Z) state may be additionally used. Also, P-channel Metal Oxide Semiconductor (PMOS) and N-channel Metal Oxide Semiconductor (NMOS), which are the terms used in the following embodiments, refer to types of a Metal Oxide Semiconductor Field-Effect Transistor (MOSFET).

FIG. 2 illustrates an integrated circuit in accordance with one embodiment of the present invention. Referring to FIG. 2, the integrated circuit includes a pad PAD for receiving an external signal, a first ESD protector 21A, a second ESD protector 21B, an input buffer 22, and an electrostatic discharge (ESD) PMOS transistor MP0. The first ESD protector 21A and the second ESD protector 21B are coupled with the pad, and provide an ESD path for a power source voltage (VDD) line 20A and a ground voltage (VSS) line 20B, respectively. The input buffer 22 receives the signal supplied to the pad through an input terminal The ESD PMOS transistor MP0 is coupled between the input terminal N1 and the VSS line 20B, and has a gate terminal coupled with the VDD line 20A. A substrate bias voltage terminal of the ESD PMOS transistor MP0 is coupled with the VDD line 20A, and thus receives VDD.

The integrated circuit may further include a power source clamp 23 coupled between the VDD line 20A and the VSS line 20B, and a resistor R disposed on a signal transfer path coupled between the pad and an input terminal N1 of the input buffer 22. Also, the power source clamp 23 provides an ESD path between the VDD line 20A and the VSS line 20B when an over-voltage, or over-current, of higher than a predetermined level is applied. The resistor R protects the internal circuit, such as the input buffer 22, from being damaged by an over-current transferred through the signal transfer path from the pad.

The first ESD protector 21A and the second ESD protector 21B are generally formed using a diode, a grounded gate MOSFET (GGMOS), a gate-coupled MOSFET (GCMOS), a bipolar junction transistor (BJT), or other MOS devices. When ESD occurs, a current path is formed with the power source line to protect an internal device and an internal circuit from an over-current.

Hereafter, the structure and operation of protecting the above-described integrated circuit against static electricity according to an exemplary embodiment of the present invention will be described in detail.

When a power source is applied to the integrated circuit in a normal operation mode, the ground voltage is applied to the gate terminal and substrate bias voltage terminal of the ESD PMOS transistor MP0. Thus, the ESD PMOS transistor MP0 maintains a turn-off state and does not affect the operation of the input buffer 22. Therefore, the input signal supplied through the pad is transferred to the input terminal N1 of the input buffer 22, and the input signal is buffered in the input buffer 22. In other words, the first ESD protector 21A, the second ESD protector 21B, the power source clamp 23, and the ESD PMOS transistor MP0 do not affect the operation of the input buffer 22, and thus are not regarded as parasitic capacitance components in the normal operation mode of the integrated circuit.

Meanwhile, when the integrated circuit is in a non-operational state, the power source is not applied to the power source line. Thus, the gate terminal and substrate bias voltage terminal of the ESD PMOS transistor MP0 are in a floating state. When the ESD is released to the pad, a certain level of voltage caused by the static electricity (i.e., from ESD) is released before the first ESD protector 21A and the second ESD protector 21B are driven, i.e., before they are turned on and form current paths to the VDD line 20A and the VSS line 20B, respectively. In response to the voltage, the ESD PMOS transistor MP0 transmits an over-current to the power source line, based on the BJT phenomenon occurring internally, to protect the input terminal N1 of the input buffer 22 from being damaged. However, since the substrate bias voltage terminal and gate terminal of the ESD PMOS transistor MP0 are in the floating state, a trigger voltage internally turned on is relatively low, compared to a case when the substrate bias voltage terminal and the gate terminal are coupled with the VSS line 20B. Therefore, the protection capability for the internal circuit and the internal device, such as the input buffer 22, is enhanced in the initial stage of the ESD phenomenon, that is, before the first ESD protector 21A and the second ESD protector 21B are driven.

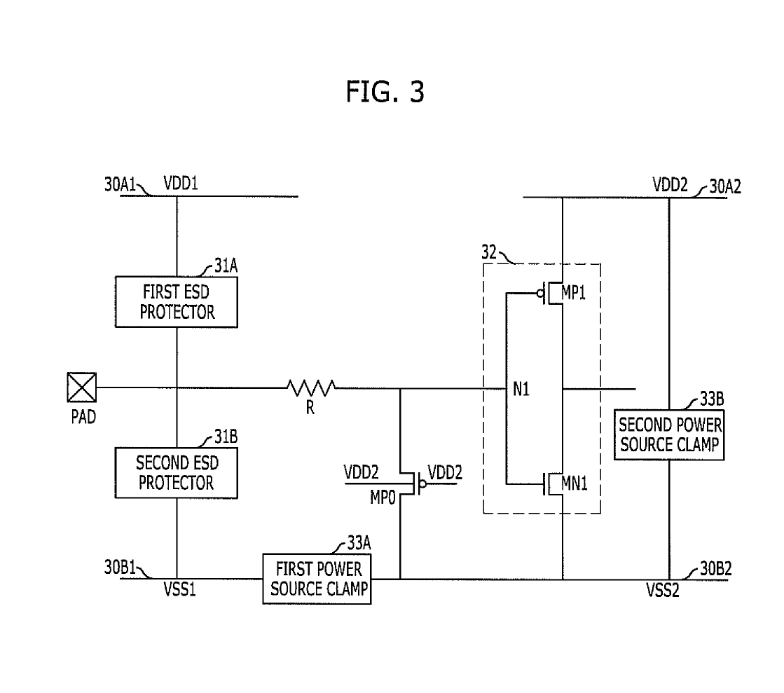

FIG. 3 illustrates an integrated circuit in accordance with another embodiment of the present invention. Referring to FIG. 3, the integrated circuit includes a pad PAD for receiving an external signal, a first ESD protector 31A, a second ESD protector 31B, an input buffer 32, and an ESD PMOS transistor MP0. The first ESD protector 31A and the second ESD protector 31B are coupled with the pad and provide an ESD path to a first power source voltage (VDD1) line 30A1 and a first ground voltage (VSS1) line 30B1, respectively. The input buffer 32 receives the signal supplied to the pad through an input terminal N1. The ESD PMOS transistor MP0 is coupled between the input terminal N1 of the input buffer 32 and a second power source voltage (VSS2) line 30B2, and has a gate terminal coupled with a second power source voltage (VDD2) line 30A2. A substrate bias voltage terminal of the ESD PMOS transistor MP0 is coupled with the VDD2 line 30A2, and receives a second power source voltage.

The integrated circuit shown in FIG. 3 includes the same constituent elements as the elements of the integrated circuit of FIG. 2, their basic performances are the same.

However, while the integrated circuit of FIG. 2 operates based on a single power source voltage VDD and a single ground voltage VSS, the integrated circuit of FIG. 3 operates based on the first and second power source voltages VDD1 and VDD2 and the first and second ground voltages VSS1 and VSS2. The integrated circuit of FIG. 3 also includes a first power source clamp 33A and a second power source clamp 33B to provide an ESD path between the VDD lines and the VSS lines, as will be explained below.

In one exemplary embodiment, the first and second power source clamps 33A and 33B provide an ESD path between the power source lines when an over-voltage, or over-current, of higher than a predetermined level is applied.

Also, a resistor R is disposed on a signal transfer path, coupled between the pad and the input terminal N1 of the input buffer 32. The resistor R protects an internal circuit, such as the input buffer 32, from being damaged by an over-current transferred through the signal transfer path from the pad.

The first ESD protector 31A and the second ESD protector 31B are generally formed using a diode, a grounded gate MOSFET (GCMOS), a gate-coupled MOSFET (GCMOS), a bipolar junction transistor (BJT), or other MOS devices. When ESD occurs, a current path is formed with a power source line to protect an internal device and an internal circuit from an over-current.

Hereafter, the structure and operation of protecting the above-described integrated circuit against static electricity according to another exemplary embodiment of the present invention will be described in detail.

When a power source is applied to the integrated circuit in a normal operation mode, a second power source voltage VDD2 is applied to the gate terminal and substrate bias voltage terminal of the ESD PMOS transistor MP0. Thus, the ESD PMOS transistor MP0 maintains a turn-off state and does not affect (for example, interfere with) the operation of the input buffer 32. Therefore, the input signal supplied through the pad is transferred to the input terminal N1 of the input buffer 32, and the input signal is buffered in the input buffer 32. In other words, the first ESD protector 31A, the second ESD protector 31B, the first power source clamp 33A, the second power source clamp 33B, and the ESD PMOS transistor MPG do not affect the operation of the input buffer 32, and thus are not regarded as parasitic capacitance components in the normal operation mode of the integrated circuit.

Meanwhile, when the integrated circuit is not in a non-operational state, the power source is not applied to the power source lines. Thus, the gate terminal and substrate bias voltage terminal of the ESD PMOS transistor MP0 are in a floating state. When ESD is released to the pad, a certain level of voltage caused by the static electricity (i.e., from the ESD) enters is released before the first ESD protector 31A and the second ESD protector 31B care driven, i.e., before they are turned on and form current paths to the power source lines. In response to the voltage, the ESD PMOS transistor MP0 transmits an over-current to the power source line, based on a parasitic BJT phenomenon occurring internally, to protect the input terminal N1 of the input buffer 32 from being damaged. Since the substrate bias voltage terminal and gate terminal of the ESD PMOS transistor MP0 are in the floating state, a trigger voltage internally turned on is relatively low, compared to a case when the substrate bias voltage terminal and the gate terminal are coupled with a ground voltage line. Therefore, the protection capability for the internal circuit and the internal device, such as the input buffer 32, is enhanced in the initial stage of the ESD phenomenon, that is, before the first ESD protector 31A and the second ESD protector 31B are driven.

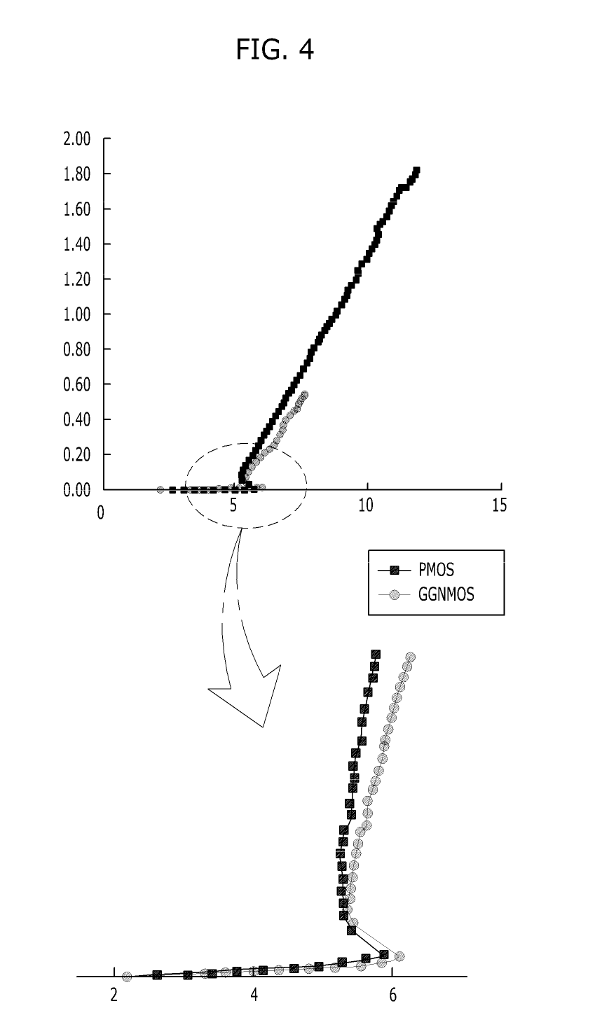

FIG. 4 shows an ESD test results for an integrated circuit that uses the ESD protection circuit in accordance with an exemplary embodiment of the present invention. Specifically, FIG. 4 shows graphs of test results for an ESD PMOS transistor and a GGNMOS transistor. It can be seen from the graphs that the ESD PMOS transistor has a lower trigger voltage, that is, a voltage of a primary breakdown, than a GGNMOS transistor. Also, since the ESD PMOS transistor has a smaller internal resistance value when it is turned on, it can bring about more advantageous effects, such as larger current flow.

The ESD PMOS transistor, fabricated in accordance with an exemplary embodiment of the present invention, is turned on with a voltage obtained from ESD, and thus transmits an over-current to a power source line to decrease a trigger voltage. Therefore, it can improve protection of an internal circuit from ESD, especially when the internal circuit is in a non-operational state.

While the present invention has been described with respect to the specific embodiments, it will be apparent to those skilled in the art that various changes and modifications may be made without departing from the spirit and scope of the invention as defined in the following claims.

For example, the construction of active high or active low for representing the activation state of a signal and a circuit may be different according to an embodiment. Also, a transistor with a different structure may be implemented while achieving the same function. In other words, a PMOS transistor may be replaced with an NMOS transistor, and other diverse transistors may be realized according to different design needs. Also, a logic gate with a modified structure may be used while achieving the same function. In other words, a NAND unit or a NOR unit may be realized as a NAND gate, a NOR gate, an inverter, or a combination thereof. Since the modification of a circuit may be performed in different ways and such a modification would be obvious to those skilled in the art to which the present invention pertains, further description as to such modifications are omitted.

What is claimed is:

1. An integrated circuit, comprising:
a pad configured to receive an external signal;
an electrostatic discharge (ESD) protector coupled with the pad to provide an ESD path to a power source voltage line and a ground voltage line; and
an input buffer configured to receive the signal applied to the pad through an input terminal.

2. The integrated circuit of claim 1, further comprising:
a power source clamp coupled between the power source voltage line and the ground voltage line.

3. The integrated circuit of claim 2, further comprising:
a resistor disposed on a signal transfer path coupled between the pad and the input terminal of the input buffer.

4. The integrated circuit of claim 2, wherein the power source clamp provides the ESD path between the power source voltage line and the ground voltage line when an over-voltage or over-current higher than a predetermined level is applied.

5. The integrated circuit of claim 1, wherein the electrostatic discharge (ESD) protector is selected from a diode, a grounded gate MOSFET (GGMOS), a gate-coupled MOSFET (GCMOS), a bipolar junction transistor (BJT) and other MOS devices.

6. The integrated circuit of claim 1, further comprising:
a protecting unit coupled between the input terminal of the input buffer and the ground voltage line and enabled by the power source voltage line.

7. The integrated circuit of claim 6, wherein the protecting unit includes
a PMOS transistor coupled between the input terminal of the input buffer and the ground voltage line, with a gate terminal coupled with the power source voltage line.

8. The integrated circuit of claim 7, wherein the PMOS transistor has a substrate bias voltage terminal coupled with the power source voltage line.

9. The integrated circuit of claim 7, wherein when the power source voltage is applied to the integrated circuit in a normal operation mode, the ground voltage is applied to the gate terminal and substrate bias voltage terminal of the PMOS transistor.

10. The integrated circuit of claim 9, wherein the PMOS transistor is configured to maintain a turn-off state without affecting the operation of the input buffer.

11. The integrated circuit of claim 8, wherein when the power source voltage is not applied to the integrated circuit in a non-operational state, the gate terminal and substrate bias voltage terminal of the PMOS transistor are configured to be in a floating state.

12. The integrated circuit of claim 11, wherein the PMOS transistor is configured to transmit an over-current to the power source line based on the BIT phenomenon occurring internally to protect the input terminal of the input buffer from being damaged when the ESD occurs to the pad.
